(19) United States
(12) Patent Application Publication
(10) Pub. No.: US 2026/0299308 A1
(43) Pub. Date: Oct. 1, 2026

(54) IMAGE LIGHT GUIDE WITH NOSE-BRIDGE SPACER

(71) Applicant: Vuzix Corporation, West Henrietta, NY (US)

(72) Inventors: Tyler W. Porter, Honeoye Falls, NY (US); Cody O'Connor, Fairport, NY (US); Russell D. Page, Philadelphia, TN (US)

(21) Appl. No.: 19/480,817

(22) PCT Filed: May 2, 2024
(86) PCT No.: PCT/US2024/027504

§ 371 Date: Nov. 2, 2025

Related U.S. Application Data
(60) Provisional application No. 63/463,524, filed on May 2, 2023.

(51) Int. Cl. G02B 27/01; G02C 1/00; G02C 5/12; G02C 5/14; G02C 7/08; G02C 9/04; G02C 11/00

(52) U.S. Cl. CPC G02B 27/0176; G02C 1/10; G02C 5/126; G02C 5/146; G02C 7/088; G02C 9/04; G02C 11/10; G02B 2027/0156; G02B 2027/0178

(57) ABSTRACT

An image light guide system for viewing a virtual object and a real-world object within a common field of view, including a frame having a right-eye rim section, a left-eye rim section, and a nose-bridge portion; an image source connected to the frame operable to emit image-bearing light beams; an image light guide configured to direct the image-bearing light beams toward an eyebox; a nose bridge spacer in contact with at least a portion of nose bridge portion, wherein the nose bridge spacer is removable; and a nose pad portion in contact with the nose bridge spacer, wherein the nose pad portion is removable.

### TECHNICAL FIELD

The present disclosure generally relates to image light guide systems, and more particularly to image light guide systems or augmented reality devices with modular components.

### BACKGROUND

Head-mounted displays (HMDs) increasingly take the form of conventional eyeglasses with less obtrusive optics for conveying virtual image content with unobstructed views of the ambient environment. Image generators can be supported along eyeglass temples, and substantially transparent image light guides convey the generated images to the wearer's eye(s) as virtual images that are projected into the wearer's real-world view visible through the image light guides.

The virtual image content can be conveyed along the image light guides as a set of angularly related beams, where the relative angular orientation of each beam in two angular dimensions corresponds to a different position (e.g., pixel) within the generated image. Typically, the beams themselves are collimated as if corresponding to a distant point source located at a unique angular position within the field of view. Thus, when the collimated beams are directed into overlapping positions within a common eyebox, the wearer's eye views the generated images from the eyebox as virtual images located at a distance approaching infinity. However, real-world objects of interest to the wearer may be located much closer and require some noticeable eye accommodation to bring into focus. Viewing virtual objects and real-world objects requiring different focusing accommodations within the same scene can cause eye strain.

Vision problems within the wearer's eyes caused by refractive errors such as nearsightedness (myopia), farsightedness (hyperopia), and astigmatism, can also present challenges to low profile HMDs resembling conventional eyeglasses. If a wearer's traditional eyeglasses (containing corrective lenses) must be removed to accommodate a low-profile HMD, the wearer's view of both real-world and virtual objects through the HMDs can be compromised.

Additionally, wearers of HMDs have diverse nose bridge depths and/or sizes which can affect wearer eye position relative to the eyebox and the general comfort of wearing HMDs.

### SUMMARY

The present disclosure is directed to one or more exemplary embodiments of an image light guide system having a removable nose bridge spacer and a removable modular lens assembly configured to manage focusing discrepancies between real-world and virtual objects presented to the viewer. These and other aspects, objects, features, and advantages of the present disclosure will be more clearly understood and appreciated from the following detailed description of the embodiments and appended claims, and by reference to the accompanying drawing figures.

In an exemplary embodiment, the present disclosure provides an image light guide system for viewing a virtual object and a real-world object within a common field of view, including a frame having a right-eye rim section, a left-eye rim section, and a nose-bridge portion; an image source connected to the frame operable to emit image-bearing light beams; an image light guide configured to direct the image-bearing light beams toward an eyebox; a nose bridge spacer in contact with at least a portion of nose bridge portion, wherein the nose bridge spacer is removable; and a nose pad portion in contact with the nose bridge spacer, wherein the nose pad portion is removable.

In another exemplary embodiment, the present disclosure provides an image light guide system for viewing a virtual object and a real-world object within a common field of view, including a frame having a right-eye rim section, a right temple, a left-eye rim section, a left temple, and a nose-bridge portion; an image source connected to the frame operable to emit image-bearing light beams; an image light guide configured to direct the image-bearing light beams toward an eyebox; a power source housing connected with one of the left-eye rim section and the right-eye rim section; a removable nose bridge spacer arranged inward of the nose bridge portion; a removable nose pad portion arranged inward of the nose bridge spacer; and a modular lens assembly selectively attachable to the power source housing and the nose bridge spacer.

### BRIEF DESCRIPTION OF THE DRAWING FIGURES

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1 is a top, front, left side perspective view of an image light guide system according to an exemplary embodiment of the presently disclosed subject matter.

FIG. 2 is a top, rear, left side perspective view of the image light guide system according to FIG. 1.

FIG. 3A is a top, rear, right side perspective view of the image light guide system according to FIG. 1.

FIG. 3B is a top, rear, right side perspective cross-sectional view of a portion of the image light guide system according to FIG. 3A.

FIG. 4A is a rear elevation view of a modular lens assembly of the image light guide system according to FIG. 1.

FIG. 4B is a top, rear, left side perspective view the modular lens assembly of the image light guide system according to FIG. 4A.

FIG. 5A is a rear elevation view of a nose bridge spacer of the image light guide system according to FIG. 1.

FIG. 5B is a top, rear, left side perspective view the nose bridge spacer of the image light guide system according to FIG. 5A.

FIG. 6A is a rear elevation view of a nose pad portion of the image light guide system according to FIG. 1.

FIG. 6B is a top, rear, left side perspective view the nose pad portion of the image light guide system according to FIG. 6A.

FIG. 7 is a top, rear, left side partially exploded perspective view of the image light guide system according to FIG. 1.

FIG. 8 is a top, rear, left side partially exploded perspective view of a portion of the image light guide system according to FIG. 1.

FIG. 9 is a top, rear, left side partially exploded perspective view of an image light guide system according to an exemplary embodiment of the presently disclosed subject matter.

FIG. 10A is a rear elevation view of a nose bridge spacer of the image light guide system according to FIG. 9.

FIG. 10B is a top, rear, left side perspective view the nose bridge spacer of the image light guide system according to FIG. 10A.

FIG. 11A is a rear elevation view of a resilient member of the image light guide system according to FIG. 9.

FIG. 11B is a top, rear, left side perspective view of the resilient member of the image light guide system according to FIG. 11A.

FIG. 12 is a top, rear, left side perspective view of a portion of the image light guide system according to FIG. 9 in a deformed state.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

One skilled in the relevant art will recognize that the elements and techniques described herein can be practiced without one or more of the specific details, or with other methods, components, materials, etc. In some instances, well-known structures, materials, or operations are not shown or described in detail to avoid obscuring certain aspects of the present disclosure. Reference throughout the specification to “one embodiment” or “an embodiment” means that a particular feature, structure, or characteristic described in connection with the embodiment is included in at least one embodiment of the present disclosure. Thus, the appearance of the phrase “in one embodiment” or “in an embodiment” throughout the specification is not necessarily referring to the same embodiment. However, the particular features, structures, or characteristics described may be combined in any suitable manner in one or more embodiments.

Where used herein, the terms “first”, “second”, and so on, do not necessarily denote any ordinal, sequential, or priority relation, but are simply used to more clearly distinguish one element or set of elements from another, unless specified otherwise.

Where used herein, the terms “viewer”, “operator”, “observer”, “wearer”, and “user” are considered equivalents and refer to the person, or machine, that wears and/or views images using a device having an imaging light guide.

Where used herein, the term “set” refers to a non-empty set, as the concept of a collection of elements or members of a set is widely understood in elementary mathematics. Where used herein, the term “subset”, unless otherwise explicitly stated, refers to a non-empty proper subset, that is, to a subset of the larger set, having one or more members. For a set S, a subset may comprise the complete set S. A “proper subset” of set S, however, is strictly contained in set S and excludes at least one member of set S.

Where used herein, the term “about” when applied to a value is intended to mean within the tolerance range of the equipment used to produce the value, or, in some examples, is intended to mean plus or minus 10%, or plus or minus 5%, or plus or minus 1%, unless otherwise expressly specified.

Where used herein, the term “substantially” is intended to mean within the tolerance range of the equipment used to produce the value, or, in some examples, is intended to mean plus or minus 10%, or plus or minus 5%, or plus or minus 1%, unless otherwise expressly specified.

Where used herein, the term “exemplary” is intended to mean “an example of,” “serving as an example,” or “illustrative,” and does not denote any preference or requirement with respect to a disclosed aspect or embodiment.

An optical system, such as an augmented reality system, can produce a virtual image. In contrast to methods for forming a real image, a virtual image is not formed on a display surface. That is, if a display surface were positioned at the perceived location of a virtual image, no image would be formed on that surface. Virtual images have a number of inherent advantages for augmented reality presentation. For example, the apparent size of a virtual image is not limited by the size or location of a display surface. Additionally, the source object for a virtual image may be small; for example, a magnifying glass provides a virtual image of an object. In comparison with systems that project a real image, a more realistic viewing experience can be provided by forming a virtual image that appears to be some distance away. Providing a virtual image also obviates the need to compensate for screen artifacts, as may be necessary when projecting a real image.

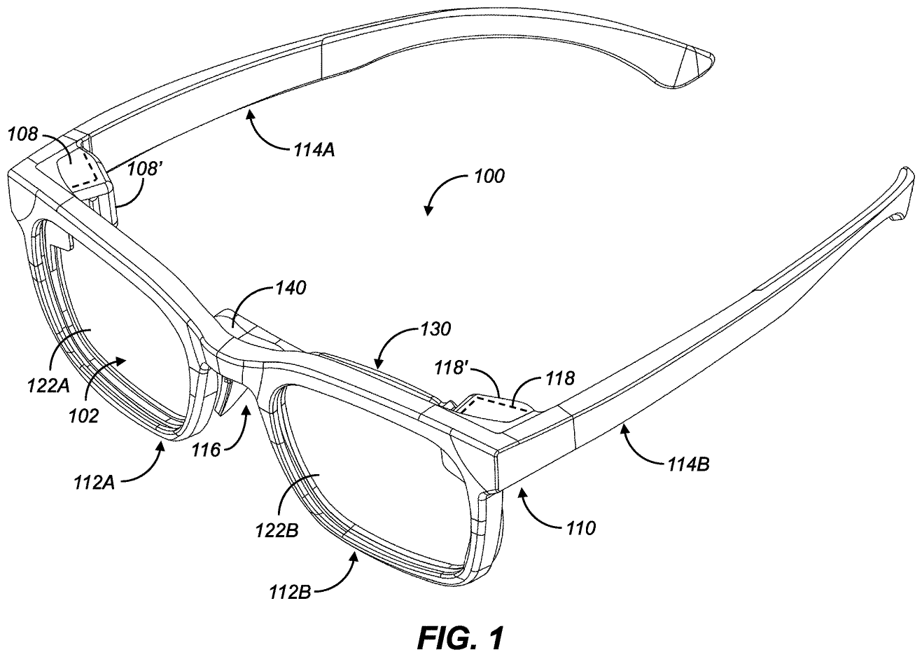

Referring now to FIG. 1, an exemplary embodiment of an image light guide system 100 according to the present disclosure can take the form of a head-mounted display, such as smart glasses, or other head-mounted optical system. As shown in FIG. 1, the example image light guide system 100 includes an image light guide 102 such as, without limitation, a transparent planar waveguide. Although not shown, image light guide 102 can include an in-coupling diffractive optic, an optional intermediate diffractive optic (or turning optic), and an out-coupling diffractive optic. It should be appreciated that image light guide 102 can be a planar or non-planar waveguide, e.g., a curved waveguide. Additionally, the image light guide 102 includes a transparent substrate, which can be made of, without limitation, optical glass, quartz, or plastic, with plane-parallel front and back surfaces. It should be appreciated that that the image light guide 102 is configured to receive angularly related image-bearing light beams and couple the angularly related image-bearing light beams into the image light guide 102 by an in-coupling diffractive optic (located along the front or back surfaces of the image light guide and configured as a transmissive-type or reflective-type diffraction element). Once coupled into image light guide 102, the angularly encoded image-bearing light beams are configured to propagate along a length dimension of the image light guide 102 and exit the image light guide 102 by interaction with an out-coupling diffractive optic, such that at least one image is formed within an eyebox for viewing by a viewer or other optical component. The image light guide 102 can also utilize one or more encounters with an intermediate diffractive optic, or turning optic, and/or the out-coupling optic to expand the size of the eyebox, or decrease positional sensitivity of the user's eye, in one or more dimensions.

Further, it should be appreciated that in one or more exemplary embodiments, the image light guide system 100 can include multiple, stacked, image light guides 102. For example, one image light guide 102 of the stack is configured to in-couple and propagate light of a first wavelength range (e.g., light in the red portion of the visible spectrum), while another image light guide 102 of the stack is configured to in-couple and propagate a second wavelength range (e.g., light in the green and/or blue portions of the visible spectrum).

As shown in FIG. 1, image light guide system 100 also includes an image source 108. In some examples, the image source 108 is a projector that includes a light source as well as one or more optical components to focus and/or collimate light generated by the light source. In some examples, image source 108 comprises one or more light-emitting diodes (LEDs), organic LEDs (OLEDs), or microLEDs (uLEDs). In other examples, image source 108 is a color field sequential projector system operable to pulse image-bearing light of multiple wavebands, for example light from within red, green, and blue wavelength ranges, onto a digital light modulator/micro-mirror array (a “DLP”) or a liquid crystal on silicon (“LCOS”) display. In further examples, image source 108 includes one or more pico-projectors, where each pico-projector is configured to produce a single primary color band (e.g., red, green, or blue). In another example, image source 108 includes a single pico-projector arranged to produce at least three primary color bands (e.g., red, green, and blue). In one example, the three primary color bands include a green band having a wavelength in the range between 495 nm and 570 nm, a red band having a wavelength in the range between 620 nm and 750 nm, and a blue band having a wavelength in the range between 450 nm and 495 nm. The substantially collimated light generated by the pico-projector, once coupled and transmitted through image light guide 102, can be used by image light guide system 100 to form one or more virtual images viewable by a user's eye or other optical components positioned within eyebox.

With continued reference to FIG. 1, image light guide system 100 also includes a frame 110 which includes a right-eye rim section 112A, a right temple 114A, a left-eye rim section 112B, a left temple 114B, and a nose-bridge portion 116. The right-eye rim section 112A is configured to receive the image light guide 102, or image light guide stack, 102 such that during operation of the image light guide system 100, the image light guide 102 is configured to form at least one image related to one or more virtual objects within a viewer's right eye. In an exemplary embodiment, the image light guide system 100 is configured as a monocular display system forming images in the right eye of the viewer. In some examples, frame 110 is made of a metal, plastic, or wood material (or any combination thereof), and is intended to be opaque, i.e., not transmissive to visible light. In some examples, image light guide 102 is removably secured within the right-eye rim section 112A between the temple 114A and nose-bridge portion 116, i.e., image light guide 102 can be removed and/or replaced without the aid of additional tools.

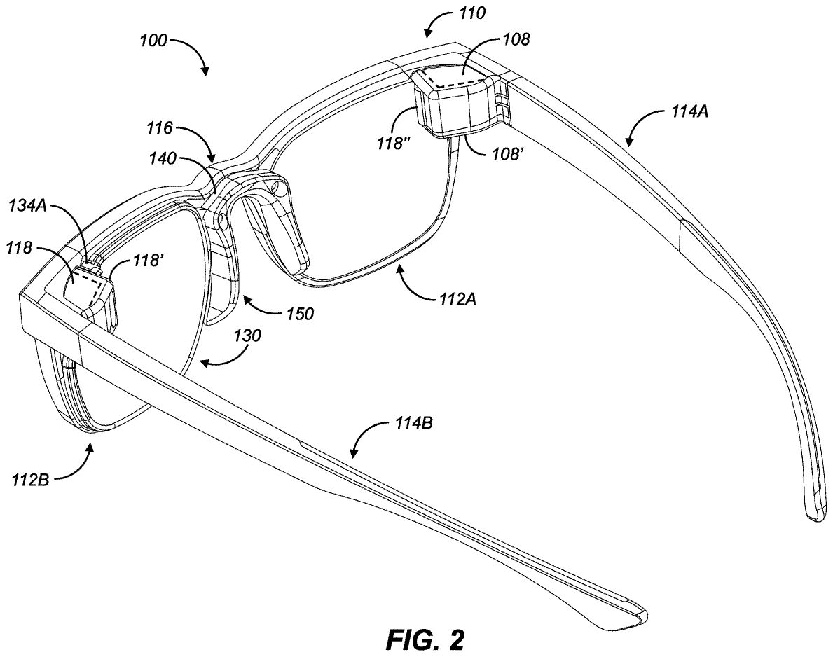

In an exemplary embodiment, the image source 108 is arranged adjacent to, and generally between, the right temple 114A and the right-eye rim section 112A. As illustrated in FIGS. 1 and 2, the image source 108 may be generally contained within a housing 108A. The image light guide system 100 also includes a power source 118 having a housing 118′ arranged adjacent to, and generally between, the left temple 114B and the left-eye rim section 112B. The power source 118 is in electrical connection with the image source 108 via one or more flexible, or flex, cables arranged at least partially through the nose-bridge portion 116. The power source 118 is also in electrical connection with a controller including a processor and non-transitory computer-readable memory configured to execute and store, respectively, a set of computer-readable instructions operable to provide images to the image source 108.

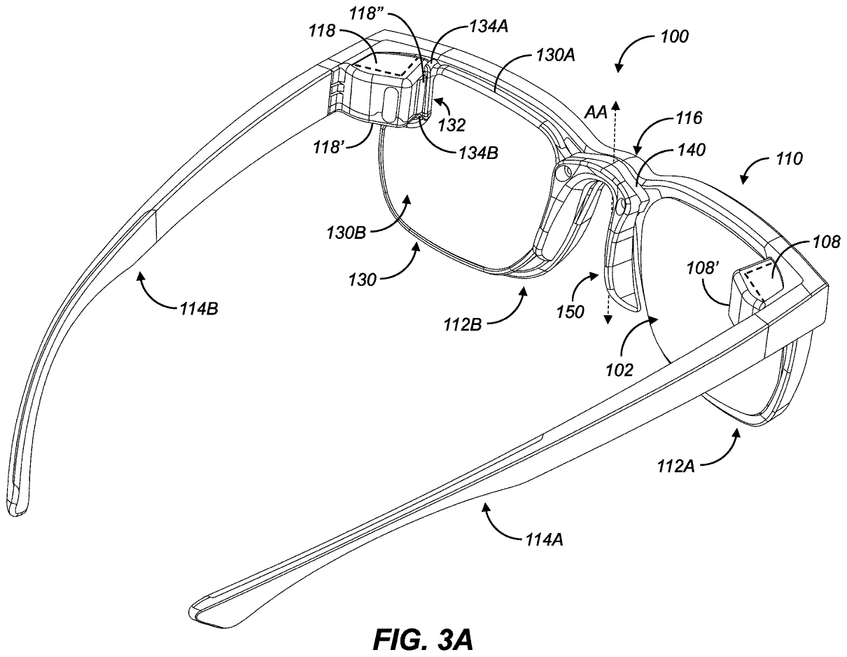

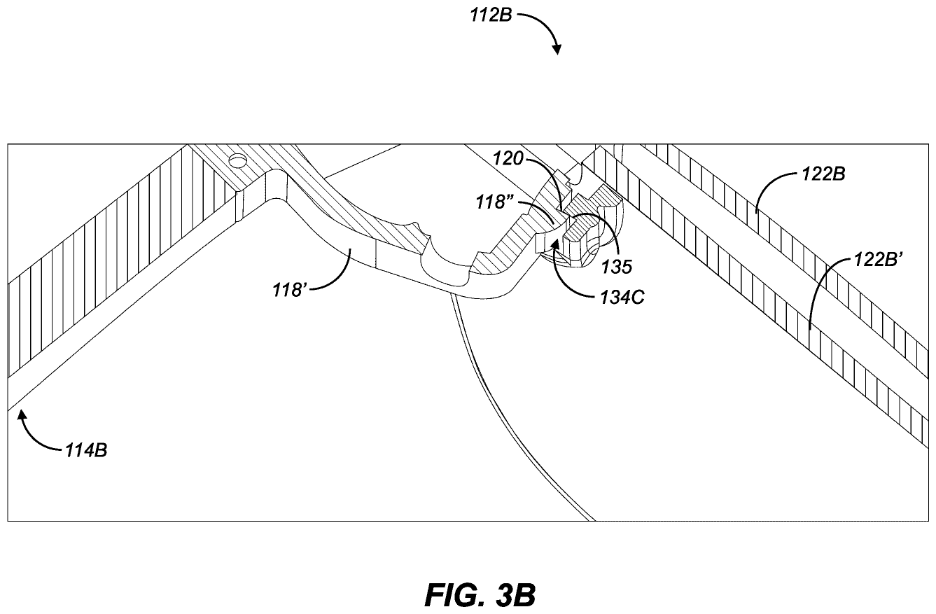

Additionally, as shown in FIG. 1, the image light guide system 100 can further include a cover window or other protective outer cover 122A, 122B arranged at least partially in the right-eye rim section 112A and the left-eye rim section 112B, respectively. In some examples, an anti-reflective coating can be provided on the front and/or back surface of the protective outer cover 122A, 122B. In some examples, as the protective outer cover 122A is located between the image-light guide 102 and real-world objects, protective outer cover 122A can provide filtering or other optical functions that affect the viewer's view of real-world objects without affecting the viewer's view of the virtual objects. In some examples, the image light guide system 100 can further include additional cover windows, such that cover windows 122A, 122B are outer cover windows (at least partially located on a side of the frame 110 opposite the user), and additional inner cover windows located between the user and the frame 110. For example, as illustrated in FIG. 3B, the left-eye rim section 112B includes the inner cover window 122B′. In some examples, the respective outer cover windows, the image light guide (or image light guide stack) 102, and the respective inner cover windows form a single module that can be inserted or removed from one or more slots located within the left- or right-eye rim sections 112A, 112B. In an example embodiment of a monocular system, the left- or right-eye rim section 112A, 112B not including the image light guide (or image light guide stack) 102 includes a unitary lens having a thickness matching the thickness of the single module including a outer cover window, the image light guide (or image light guide stack) 102, and a respective inner cover window.

Referring now to FIGS. 2-3B, an exemplary embodiment of the image light guide system 100 includes a modular lens assembly 130 arranged at least partially between the left-eye rim section 112B and the viewer. As shown, the modular lens assembly 130 is removably connected to the power source housing 118′ and a nose bridge spacer 140. The modular lens assembly 130 includes a frame 130A and one or more lenses 130B. The modular lens assembly frame 130A includes a contour similar to that of the left-eye rim section 112B, with a cutout 132 generally shaped to at least partially surround the right-eye rim surfaces of the power source housing 118′.

In an example embodiment, the power source housing 118′ includes a projection, or rib, 118″ protruding from the surface of the power source housing 118′ in the direction of the right-eye rim section 112A. The modular lens assembly frame 130A includes a pair of resilient tabs 134A, 134B arranged on or in the cutout 132, and a recessed portion 134C positioned between the resilient tabs 134A, 134B. At least one of the resilient tabs 134A, 134B or the recessed portion 134C are configured to engage with the projection 118″. In an example embodiment, the projection 118″ includes a generally quarter-cylinder shape and the resilient tabs 134A, 134B generally engage with the ends of the projection 118″ while the majority of the projection 118″ sits within recessed portion 134C. As illustrated in FIG. 3B, a flat or planar surface 120 of the projection 118″ abuts a flat or planar surface 135 at least partially defined by the recessed portion 134C. The nature of the mechanical interaction between the flat surface 120 and the flat surface 135 at least partially maintains the position of the modular lens assembly 130 along a horizontal direction; for example, along the direction toward the wearer. It should be appreciated that the projection 118″ may take other forms in addition to the generally quarter-cylinder shape, including, without limitation, a half-cylinder, a generally discoid, an elongated pyramid, or a rectangular shape. In an example embodiment, only one of the tabs 134A, 134B is resilient, while the non-resilient tab 134A, 134B serves a bracing function to provide an opposing force to that of the resilient tab 134A, 134B.

While the drawings show only a modular lens assembly 130 associated with the left-eye rim section 112B for clarity and ease of understanding, it should also be appreciated that a second modular lens assembly 130 associated with right-eye rim section 112A may also be utilized in conjunction with the modular lens assembly 130 associated with the left-eye rim section 112B, the second modular lens assembly 130 having the same features as the modular lens assembly 130 associated with the left-eye rim section 112B arranged in symmetry about the nose bridge portion 116. To effect removable attachment of the modular lens assembly 130 associated with right-eye rim section 112A, the image source housing 108A also includes a projection, or rib, 118″ protruding from the surface of the image source housing 108A in the direction of the left-eye rim section 112B. Similarly, and as further discussed below, the nose bridge spacer 140 is symmetric to facilitate engagement of the first and/or the second modular lens assemblies 130 with the nose bridge spacer 140.

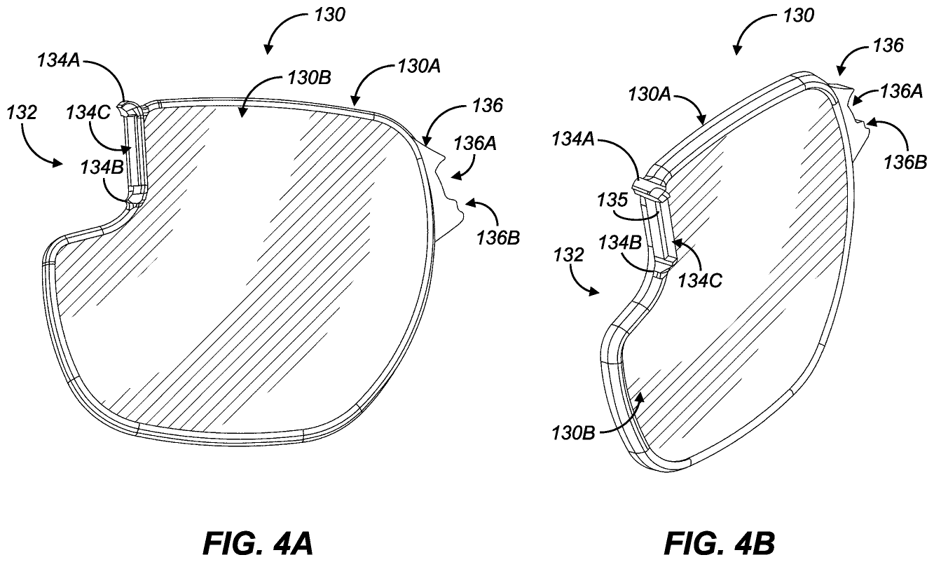

As illustrated in FIGS. 4A and 4B, in an example embodiment, the modular lens assembly frame 130A also includes a tab 136 configured to engage at least a portion of the nose bridge spacer 140. The tab 136 protrudes in a direction generally opposite the cutout 132 and includes a first recess 136A and a second recess 136B. The second recess 136B may be arranged at least partially within the first recess 136A. For example, the first recess 136A may define a generally rectangular-shape, or portion of a rectangle. As illustrated in FIG. 4A, the first recess 136A and the second recess 136B may be oriented generally upward facing; for example, at an upward facing angle.

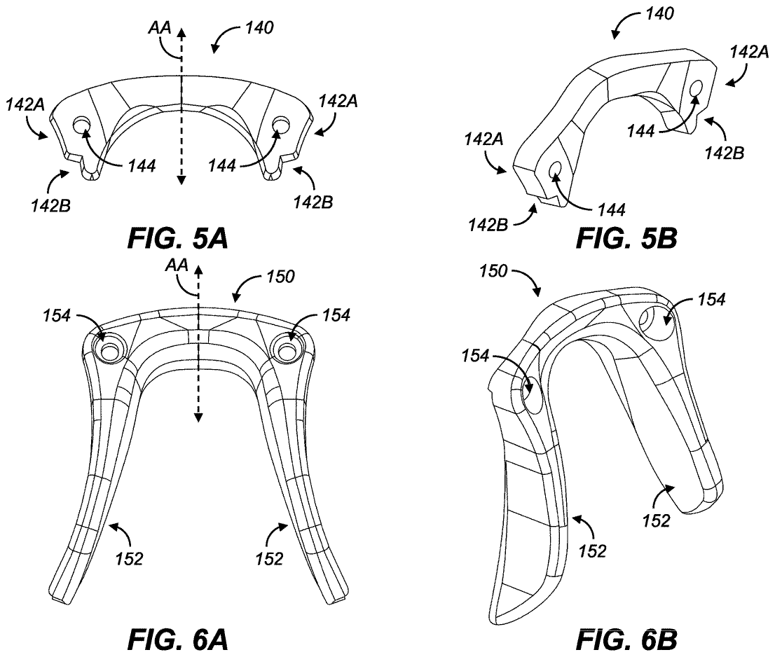

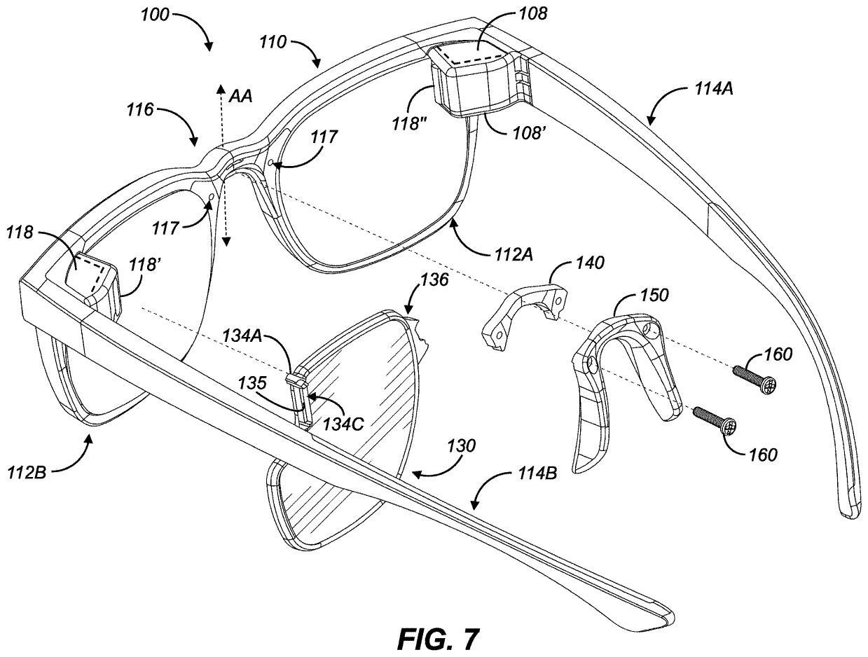

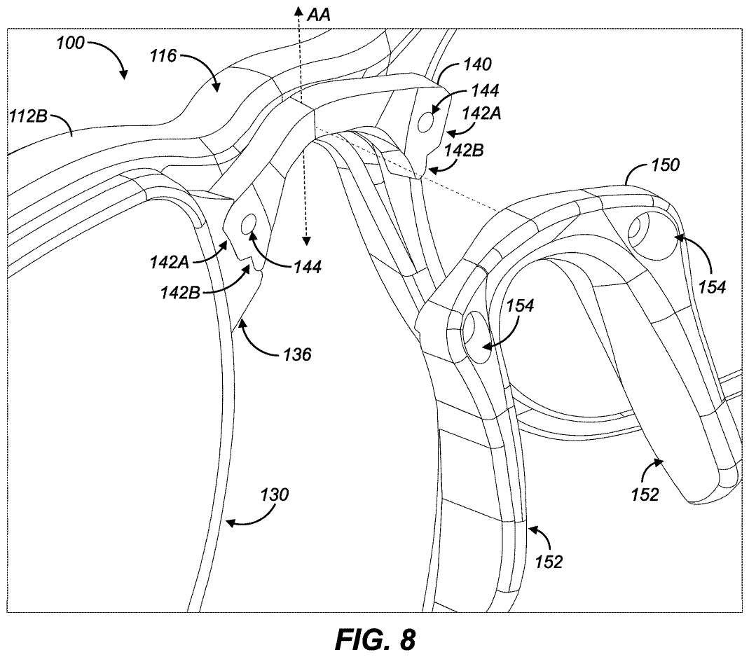

Referring now to FIGS. 5A-7, an exemplary embodiment of the image light guide system 100 includes a removable nose bridge spacer 140. The nose bridge spacer 140 is configured to be arranged between the nose bridge portion 116 and a nose pad portion 150. Advantageously, the nose bridge spacer 140 facilitates an improved fit for variable user nose bridge depth and/or size, as well as a compact, or low aesthetic impact, securement point for the modular lens assembly 130. It should be appreciated that to accommodate different fits or variable nose bridge depths for different users, the nose bridge spacer can have various thickness where an increased thickness translates to deeper nose bridge depths/fits and vice versa. It should be noted that the nose bridge spacer 140 may be utilized with and without the modular lens assembly 130. As illustrated in FIG. 5A, the nose bridge spacer 140 is symmetric about an imaginary axis AA, therefore symmetric elements are accorded like reference characters. In an exemplary embodiment, the nose bridge spacer 140 includes a generally arcuate shape, e.g., a generally upside down “U” shape, contoured to mate against the nose bridge portion 116. The nose bridge spacer 140 includes a first mating surface 142A and a second mating surface 142B configured for arrangement relative to the first recess 136A and the second recess 136B, respectively, of the modular lens assembly frame tab 136. In an example embodiment, the nose bridge spacer 140 includes the first mating surfaces 142A, and not the second mating surfaces 142B. As illustrated in FIG. 8, the form-fit nature of the mechanical connection between the modular lens assembly frame tab 136 and the nose bridge spacer 140 at least partially maintains the position of the modular lens assembly 130 along a vertical direction; for example, along the direction of the imaginary axis AA. With continued reference to FIGS. 5A-7, the nose bridge spacer 140 also includes two through-bores 144 arranged therethrough and symmetric about the imaginary axis AA. In an example embodiment, the through-bores 144 are configured to receive threaded fasteners 160, respectively, for assembly of the nose pad portion 150 and the nose bridge spacer 140 with the nose bridge portion 116. However, it should be appreciated that it is not necessary that the through-bores 144 be threaded. As shown in FIG. 7, the nose bridge portion 116, or user-facing portions of the right-eye rim section 112A and the left-eye rim section 112B, includes partial through-bores 117 symmetric about imaginary axis AA for receiving the threaded fasteners 160. For example, the partial through-bores 117 include an internal thread configured to engage at least a portion of the threaded fasteners 160.

Referring now to FIGS. 6A and 6B, the nose pad portion 150 is contoured to mate with the nose bridge spacer 140. The nose pad portion 150 is symmetric about an imaginary axis AA, therefore symmetric elements are accorded like reference characters. The nose pad portion 150 includes a left pad 152 and a right pad 152 configured to support the image light guide system 100 on the nose of a wearer. The nose pad portion 150 also includes through-bores 154 arranged therethrough and symmetric about the imaginary axis AA. It should be appreciated that it is not necessary that the through-bores 154 be threaded. In an example embodiment, the through-bores 154 include a counterbore to prevent the threaded fasteners 160 from protruding beyond a surface of the nose pad portion 150 in the direction of the wearer when assembled.

Advantageously, the image light guide system 100 is configured to accommodate both users with certain forms of optical maladies, such as myopia (near-sightedness) or astigmatism, and users without optical maladies. As mentioned above, image source 108 is configured to produce substantially collimated virtual image-bearing light. In examples of the image light guide system 100 where the image light guide 102 (or image light guide stack 102) do not introduce optical power into the in-coupled virtual image-bearing light, the images associated with virtual objects formed within the eyebox will typically be focused at optical infinity. The modular lens assembly 130 associated with the right-eye rim section 112A is, for example, configured to focus virtual objects at a closer focusing distance, i.e., a focusing distance less than optical infinity, as well as focus real real-world objects in a common field of view at a, for example, closer focusing distance. Similarly, the modular lens assembly 130 associated with the left-eye rim section 112B is, for example, configured to focus real-world objects in the field of view at a closer focusing distance. In an example embodiment, the one or more lenses 130B of the modular lens assembly 130 include a negative-power optical element operable to diverge real-world image-bearing light and/or virtual image-bearing light such that the focusing distance of any real-world objects and/or virtual objects is reduced from, for example, a first focusing distance to a second focusing distance. It should be appreciated that the one or more lenses 130B of the modular lens assembly 130 may include a positive-power optical element operable to converge real-world image-bearing light and/or virtual image-bearing light.

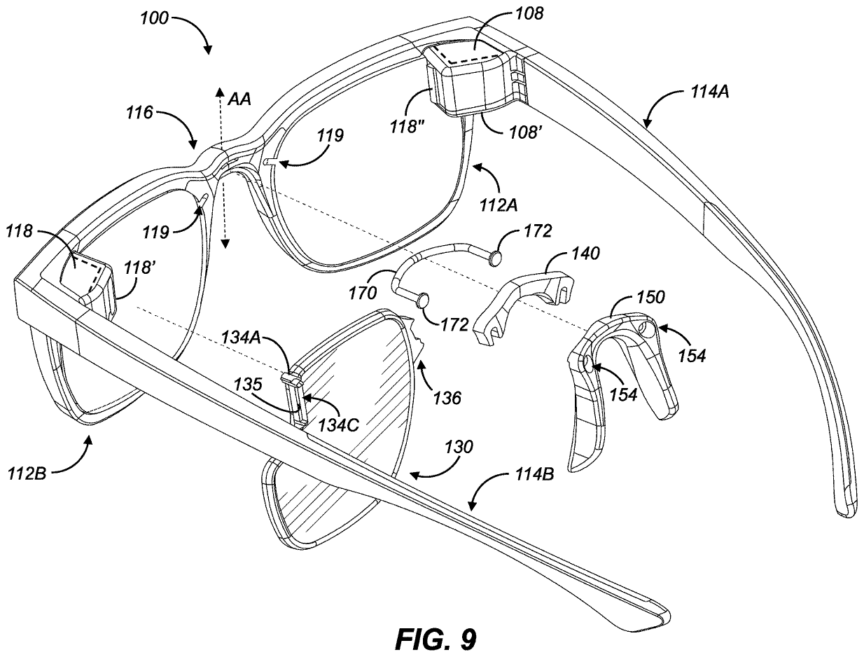

Referring now to FIGS. 9-12, in an example embodiment, the image light guide system 100 is configured for toolless addition and removal of the nose bridge spacer 140 and/or one or more modular lens assemblies 130. Components of the image light guide system 100 common to the embodiments described above and the following embodiments are denoted by like reference characters, and detailed description of them is omitted. In an example embodiment, the nose bridge portion 116, and/or nose bridge portion 116 adjacent portions of the right-eye rim section 112A and the left-eye rim section 112B, includes a channel 119 for at least partially housing a resilient member 170. The nose bridge portion 116, and/or nose bridge portion 116 adjacent portions of the right-eye rim section 112A and the left-eye rim section 112B, include channels 119 arranged symmetric about imaginary axis AA through which the resilient member 170 may extend toward the nose pad portion 150. In an example, the channels 119 open toward a radially inward surface of the right-eye rim section 112A and the left-eye rim section 112B, respectively.

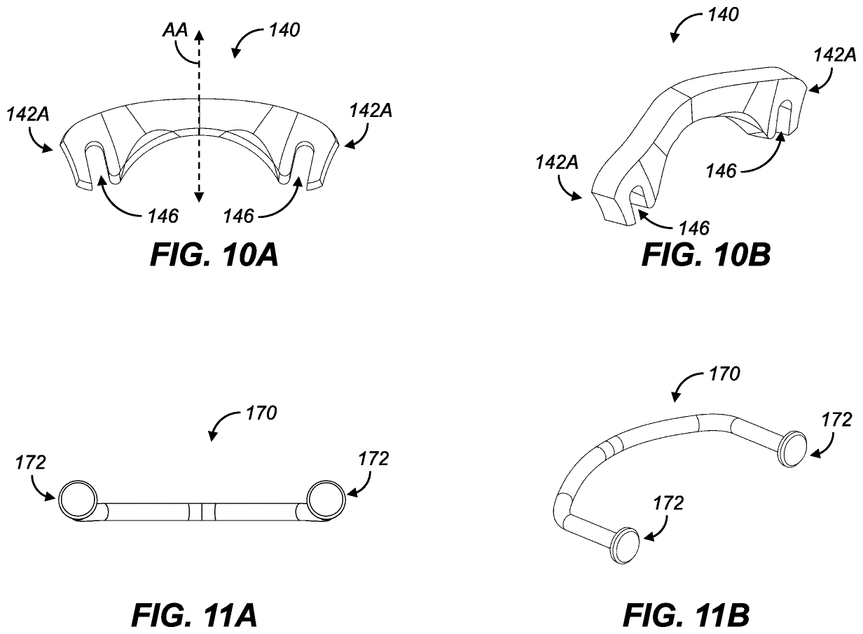

With reference to FIGS. 10A and 10B, the nose bridge spacer 140 includes two slots 146 arranged therethrough and symmetric about the imaginary axis AA. The slots 146 may be oriented to open downward and inward (toward the user when wearing the image light guide system 100), on a diagonal, toward the wearer's nose. In an example embodiment, the slots 146 are configured to receive resilient member 170, and allow the nose bridge spacer 140 to be slidably detached from the resilient member 170, for assembly and disassembly of the nose pad portion 150 and the nose bridge spacer 140 with the nose bridge portion 116. In an example embodiment, the nose bridge spacer 140 includes first mating surfaces 142A, which are configured for arrangement at least partially within the first recess 136A of the modular lens assembly frame tab 136.

As illustrated in FIGS. 11A and 11B, in an example embodiment, the resilient member 170 may include, without limitation, an elastic member (e.g., an elastic cord or strap) or a spring (e.g., coil). The resilient member 170 includes end caps 172 which secure the resilient member 170 at least partially within the nose pad portion through-bores 154, and in some embodiments within the counterbores within the respective through-bores 154. In another example embodiment, the augmented reality display system 100 may include two resilient members 170 that are unconnected and secured with the nose bridge portion 116, but are otherwise designed similarly to the single resilient member 170 embodiments.

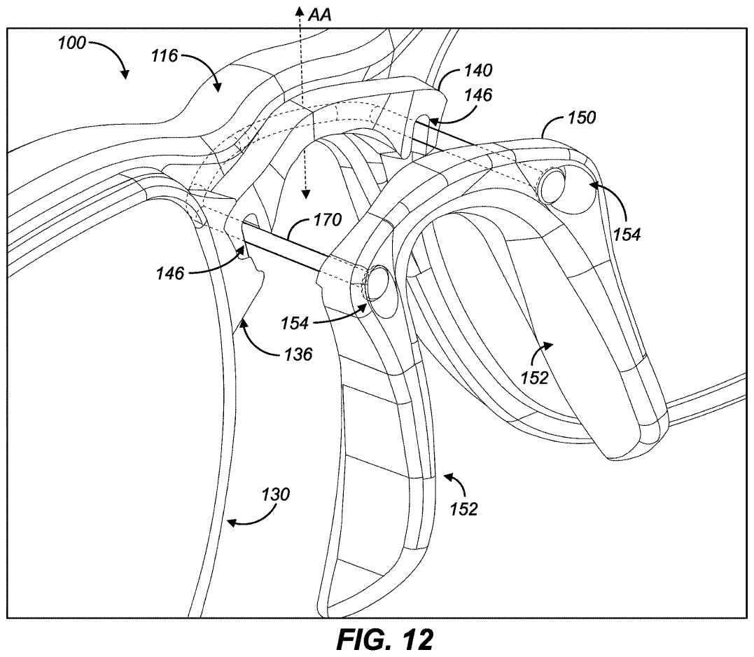

As illustrated in FIG. 12, the nose pad portion 150 may be moved (e.g., pulled by the user) in a direction opposite the nose bridge portion 116, thereby deforming the resilient member 170 into an extended (i.e., deformed) state. In the deformed state of the resilient member 170, the one or more modular lens assemblies 130 may be removed, and optionally replaced with a different prescription or lens assembly. Similarly, in the deformed state of the resilient member 170, the nose bridge spacer 140 may be removed and optionally replaced with a different thickness nose bridge spacer 140.

Given the foregoing, the following represents an operational example of a user's interaction with image light guide system 100. A user that desires a different nose bridge fit may desire to utilize a nose bridge spacer 140 to increase the distance between the nose pad portion 150 and the nose bridge portion 116 of the frame 110. The user may simply pull the nose pad portion 150 in a direction away from the nose bridge portion 116 against the elastic force (i.e., elasticity vs. plasticity) provided by the resilient member 170 into a deformed state. The space or gap between the nose pad portion 150 and the nose bridge portion 116 in the deformed state allows for the insertion of a nose bridge spacer 140 with a desired thickness. The nose bridge spacer 140 can engage with at least a portion of the resilient member 170 via the slots 146 preventing the nose bridge spacer 140 from falling out of the assembly. The user then releases the nose pad portion and the resilient member 170 resiliently rebounds to its original length/shape compressing the nose bridge spacer 140 between the nose bridge portion 116 and the nose pad portion 150. Additionally, after or contemporaneously with inserting the nose bridge spacer 140, the user may engage one or more modular lens assemblies 130 by engaging the tabs 134A, 134B with the protrusion 118″ and engaging at least first recess 136A with first mating surface 142A such that when the user releases the nose pad portion 150, the compressive force (provided by the resilient member 170) compresses and secures both the nose bridge spacer 140 and the tab 136 of the modular lens assembly 130. It should be appreciated that a similar process using the nose bridge spacer 140 configuration shown in FIGS. 5A-5B and 7 follows similar steps except that rather than deforming the resilient member 170 to make space for the nose bridge spacer 140, screws 160 are removed and reinserted when the nose bridge spacer 140 insertion/replacement is complete.

One or more features of the embodiments described herein may be combined to create additional embodiments which are not depicted. While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof. The embodiments described above are therefore to be considered in all respects as illustrative, and not restrictive. The scope of the invention is indicated by the appended claims, and all changes that come within the meaning and range of equivalents thereof are intended to be embraced therein.

What is claimed is:

1. An image light guide system for viewing a virtual object, comprising:
a frame having a right-eye rim section, a left-eye rim section, and a nose-bridge portion;
an image source connected to the frame operable to emit image-bearing light beams;
an image light guide configured to direct the image-bearing light beams toward an eyebox;
a nose bridge spacer in contact with at least a portion of nose bridge portion, wherein the nose bridge spacer is removable; and
a nose pad portion in contact with the nose bridge spacer, wherein the nose pad portion is removable.

2. The image light guide system of claim 1, further comprising a power source housing connected with one at least a portion of the left eye rim section or the right eye rim portion.

3. The image light guide system of claim 2, further comprising a modular lens assembly selectively attachable to at least a portion of the frame and the nose bridge spacer.

4. The image light guide system of claim 3, further comprising a projection arranged on a surface of the power source housing extending at least partially toward the nose bridge portion, wherein the modular lens assembly is selectively attachable to the projection.

5. The image light guide system of claim 4, wherein the modular lens assembly comprises one or more resilient tabs configured to engage the projection.

6. The image light guide system of claim 3, wherein the modular lens assembly at least partially surrounds a portion of the power source housing.

7. The image light guide system of claim 3, wherein the modular lens assembly includes a tab comprising one or more surfaces configured to engage the nose bridge spacer.

8. The image light guide system of claim 3, wherein the modular lens assembly includes one or more lenses having an optical power contribution operable to converge or diverge light.

9. The image light guide system of claim 1, wherein the nose pad portion and the nose bridge spacer include one or more coaxial through-bores, and the nose bridge portion of the frame includes one or more partial through-bores arranged coaxial with the one or more through-bores, wherein the one or more through-bores and the one or more partial-through bores are configured to receive one or more threaded fasteners.

10. The image light guide system of claim 1, further comprising an image source housing connected with one of the left-eye rim section and the right-eye rim section, wherein the image source housing at least partially encloses the image source, and a modular lens assembly selectively attachable to at least a portion of the frame and the nose bridge spacer.

11. The image light guide system of claim 10, wherein the image source housing further comprises a projection extending at least partially toward the nose bridge portion, wherein at least a portion of the modular lens assembly is selectively attachable to the projection.

12. The image light guide system of claim 10, wherein the modular lens assembly includes one or more lenses having an optical power contribution operable to converge or diverge light.

13. The image light guide system of claim 1, further comprising a resilient member arranged at least partially through the nose bridge portion and connected with the nose pad portion.

14. The image light guide system of claim 13, wherein the nose bridge spacer is slidably engaged between the nose bridge portion and the nose pad portion.

15. The image light guide system of claim 14, wherein the nose bridge spacer is slidably engaged with the resilient member via one or more slots in the nose bridge spacer.

16. The image light guide system of claim 14, wherein the resilient member is deformable when the nose pad portion is extended in a direction away from the nose bridge portion, and wherein the modular lens assembly and the nose bridge spacer may be removed when the resilient member is deformed.

17. The image light guide system of claim 1, wherein the image light guide is substantially transparent.

18. An image light guide system for viewing a virtual object and a real-world object within a common field of view, comprising:
a frame having a right-eye rim section, a left-eye rim section, and a nose-bridge portion;
an image source connected to the frame operable to emit image-bearing light beams;
an image light guide configured to direct the image-bearing light beams toward an eyebox;
a power source housing connected with one of the left-eye rim section and the right-eye rim section;
a nose bridge spacer arranged in contact with at least a portion of the nose bridge portion, wherein the nose bridge spacer is removable; and
a nose pad portion arranged in contact with of the nose bridge spacer, wherein the nose pad portion is removable;
a modular lens assembly selectively attachable to at least a portion of the power source housing and at least a portion of the nose bridge spacer.

19. The image light guide system of claim 17, wherein the image light guide is substantially transparent.
